(19) United States
(12) Patent Application Publication
(10) Pub. No.: US 2019/0114841 A1
(43) Pub. Date: Apr. 18, 2019

(54) METHOD, PROGRAM AND APPARATUS FOR PROVIDING VIRTUAL EXPERIENCE

(71) Applicant: COLOPL, Inc., Tokyo (JP)

(72) Inventor: Go SATO, Tokyo (JP)

(21) Appl. No.: 16/162,326

(22) Filed: Oct. 16, 2018

(30) Foreign Application Priority Data
Oct. 17, 2017 (JP) 2017-201180

(51) Int. Cl. G06T 19/20; G06T 19/00

(52) U.S. Cl. CPC G06T 19/20; G06T 2219/2012; G06T 19/003

(57) ABSTRACT

[Problem to be Solved] To provide a technique for reducing occurrence of VR motion sickness that users who are immersing themselves in a virtual space may develop.

[Solution to Problem]

According to at least one embodiment of this disclosure, there is provided a method. The method includes: defining a virtual space, the virtual space including a virtual point of view and a virtual object; moving the virtual point of view in a first direction; defining a line-of-sight direction associated with the virtual point of view in accordance with a motion of the head of the user; defining a field of view in the virtual space based on a position of the virtual point of view and the line-of-sight direction; detecting an angle between the first direction and the line-of-sight direction; changing visibility of the virtual object included in the field of view in accordance with the angle; generating a field-of-view image that is an image corresponding to the field of view; and causing an image display apparatus to output the field-of-view image.

### TECHNICAL FIELD

The present disclosure relates to a method, a program, and an apparatus for providing virtual experience.

### BACKGROUND

There is a known technique that provides a user with a field-of-view image corresponding to a field of view from a virtual point of view on a virtual space using a head-mounted device (HMD), thereby allowing the user to experience virtual reality (VR).

Users experiencing virtual reality may develop what is called VR motion sickness. One of the likely causes of VR motion sickness is sensory conflict between virtual experience and the user's perception or expectation.

As a technique for reducing VR motion sickness, for example, Japanese Patent No. 6092437 (Patent Document 1) discloses a technique that sets an intensity of blurring applied to an image and a range of performing the processing of blurring the image based on the magnitude of the angular velocity of the HMD (see Abstract).

### CITATION LIST

### Patent Document

[Patent Document 1] Japanese Patent No. 6092437

### SUMMARY

### Solution to Problem

According to at least one embodiment of this disclosure, there is provided a method. The method includes: defining a virtual space, the virtual space including a virtual point of view and a virtual object; moving the virtual point of view in a first direction; defining a line-of-sight direction associated with the virtual point of view in accordance with a motion of the head of the user; defining a field of view in the virtual space based on a position of the virtual point of view and the line-of-sight direction; detecting an angle between the first direction and the line-of-sight direction; changing visibility of the virtual object included in the field of view in accordance with the angle; generating a field-of-view image that is an image corresponding to the field of view; and causing an image display apparatus to output the field-of-view image.

The above-mentioned and other objects, features, aspects, and advantages of the disclosed technical features may be made clear from the following detailed description of this disclosure, which is to be understood in association with the attached drawings.

### BRIEF DESCRIPTION OF DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules in a computer according to at least one embodiment of this disclosure.

FIG. 15 A field-of-view image viewed by a user facing in a front direction.

FIG. 16 A field-of-view image viewed by a user facing in a lateral direction (rightward direction).

FIG. 17 A field-of-view image with lowered visibility of an object in the field-of-view image in FIG. 16.

FIG. 18 A flowchart of a process for lowering visibility of environment objects.

FIG. 19 A diagram of a configuration of another HMD system.

FIG. 20 A diagram of a configuration of another controller.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

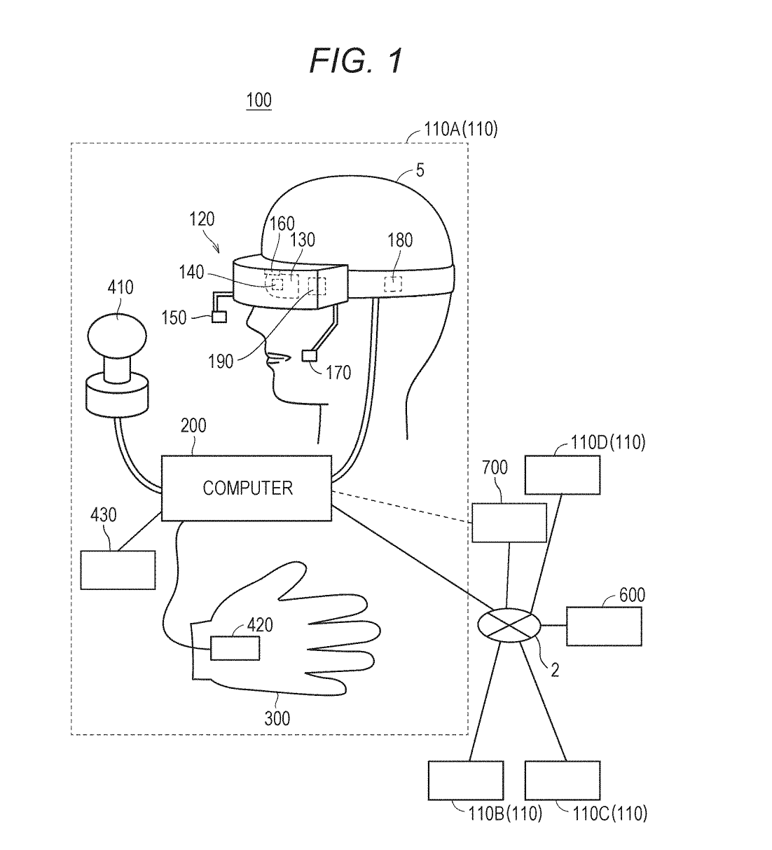

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

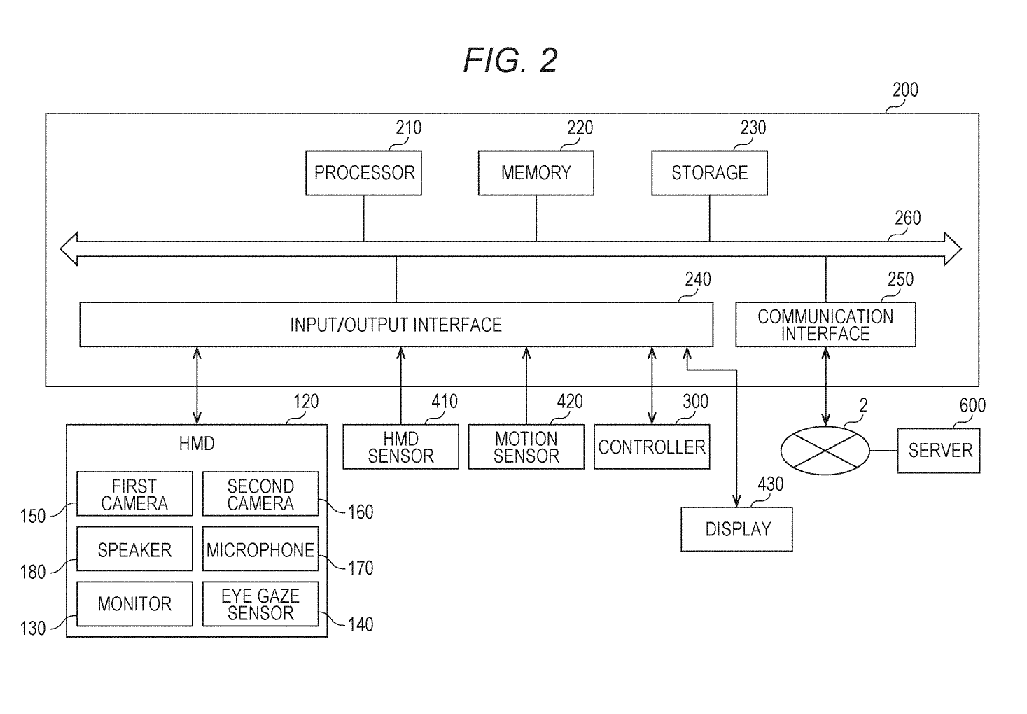

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

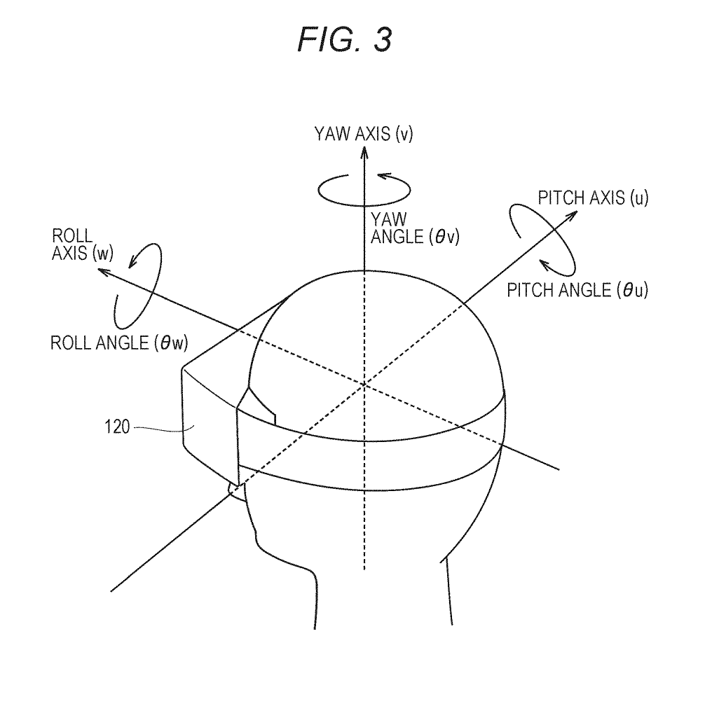

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

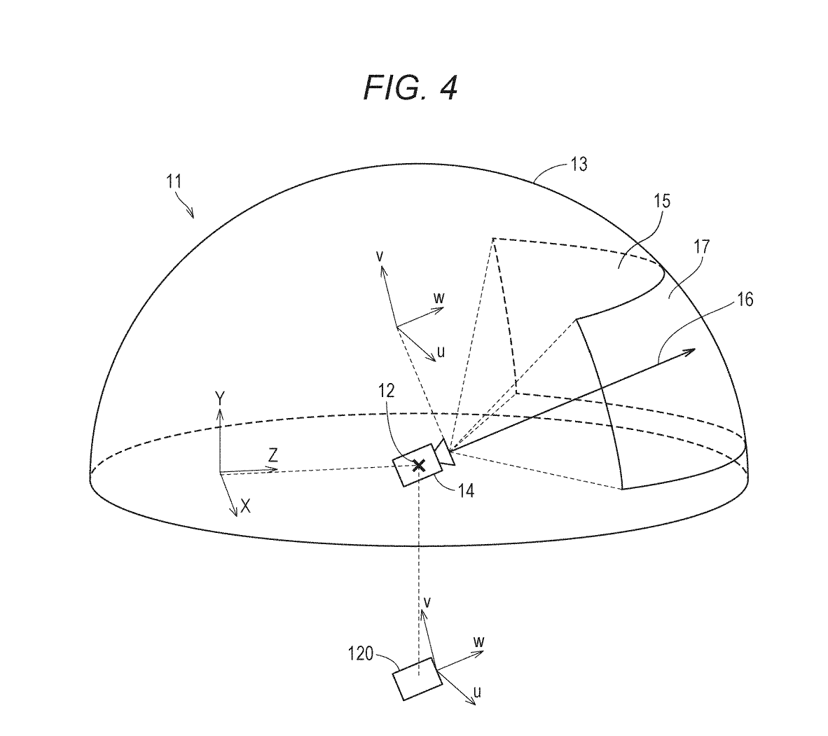

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

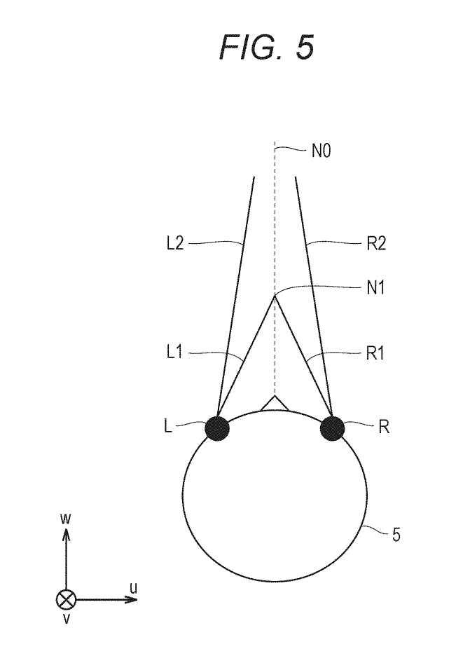

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

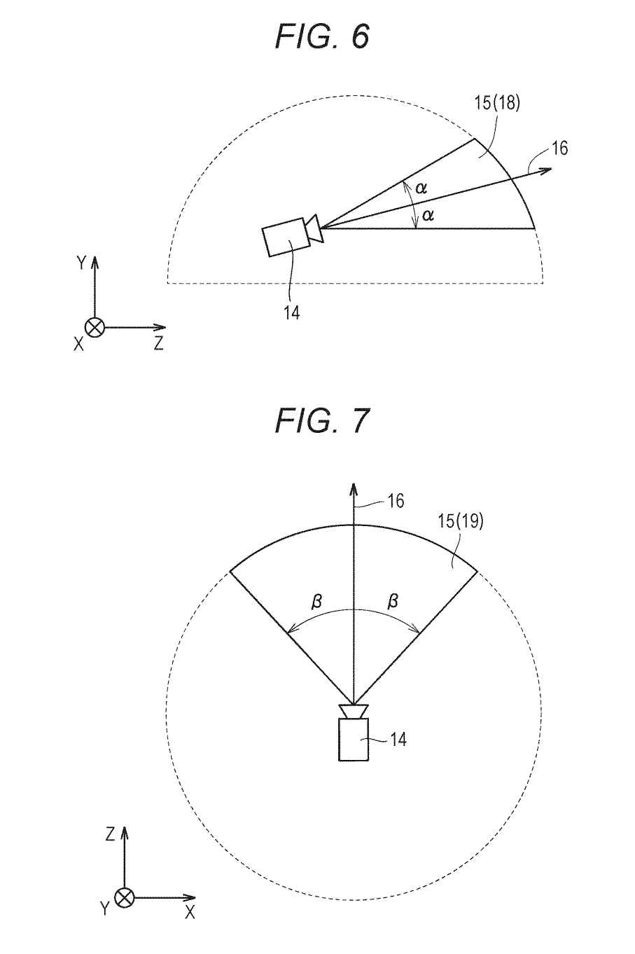

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth R from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

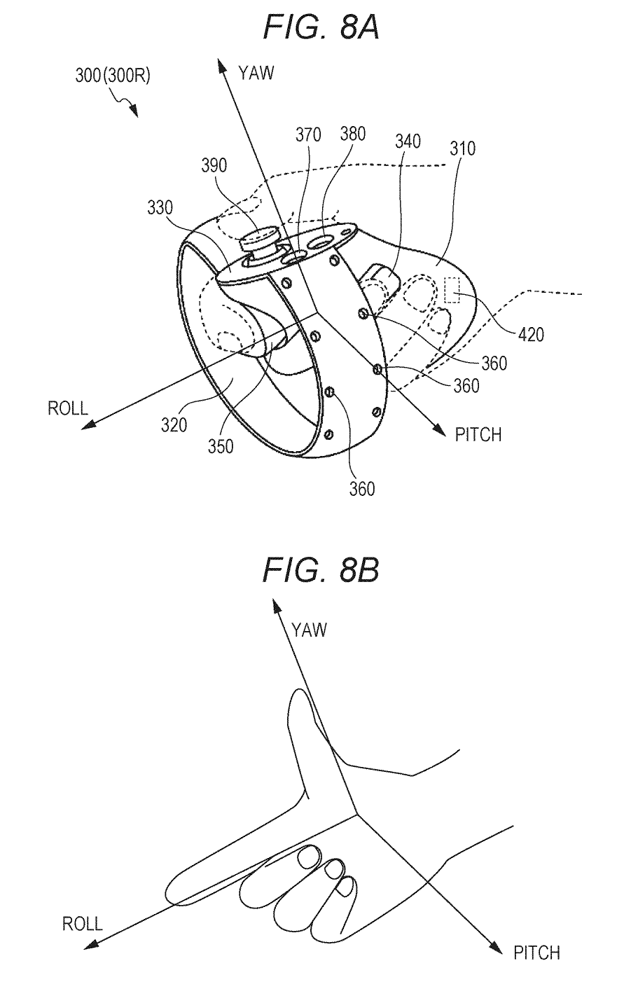

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

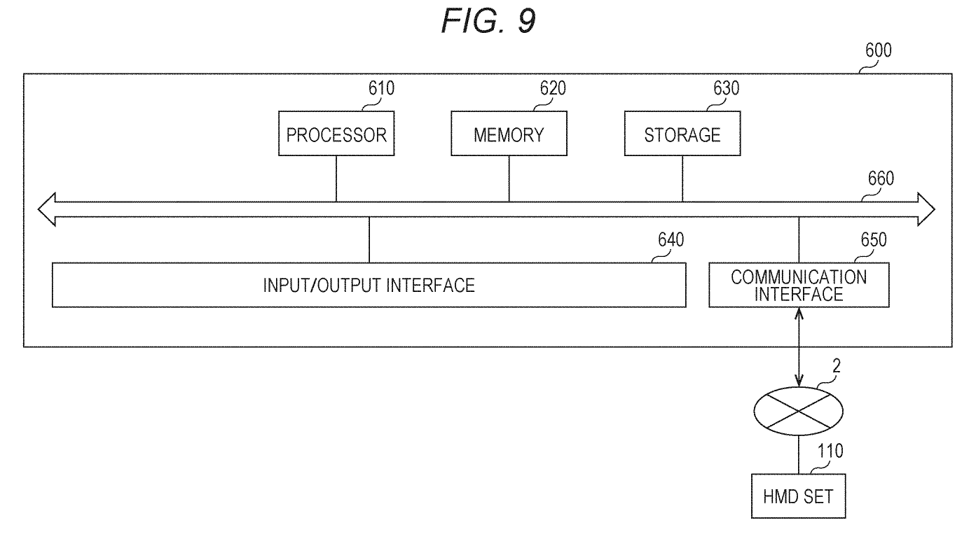

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 230 stores programs and data for a period of time longer than the memory 220, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

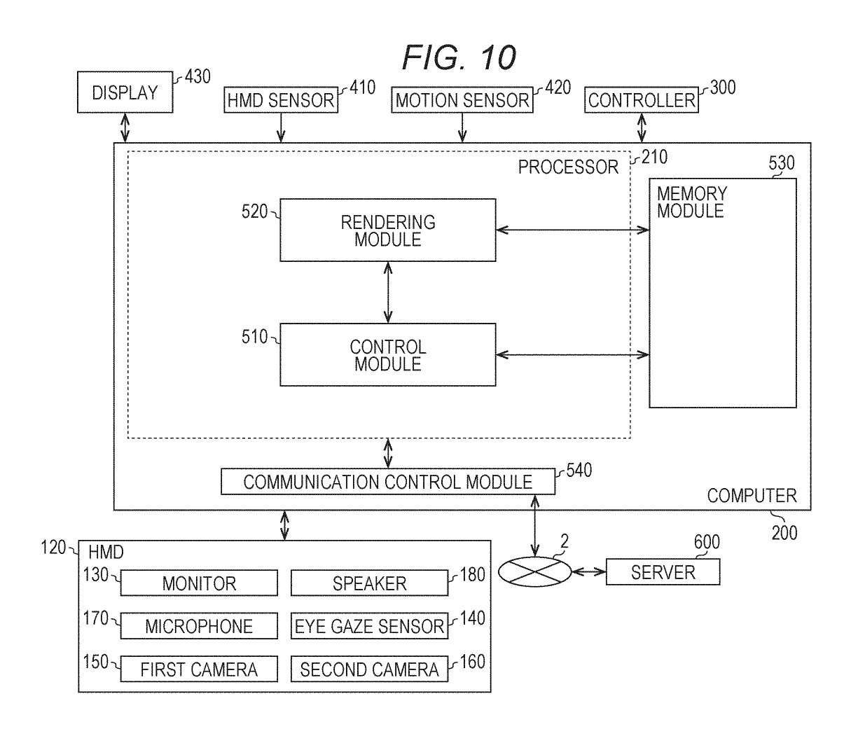

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may be provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

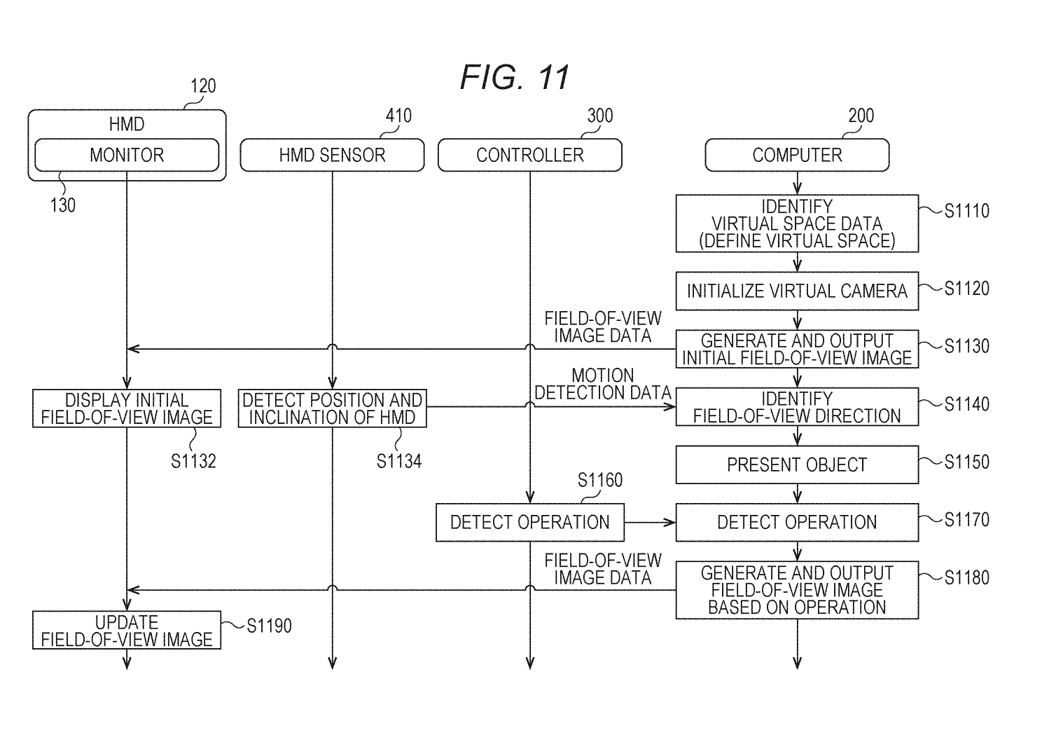

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

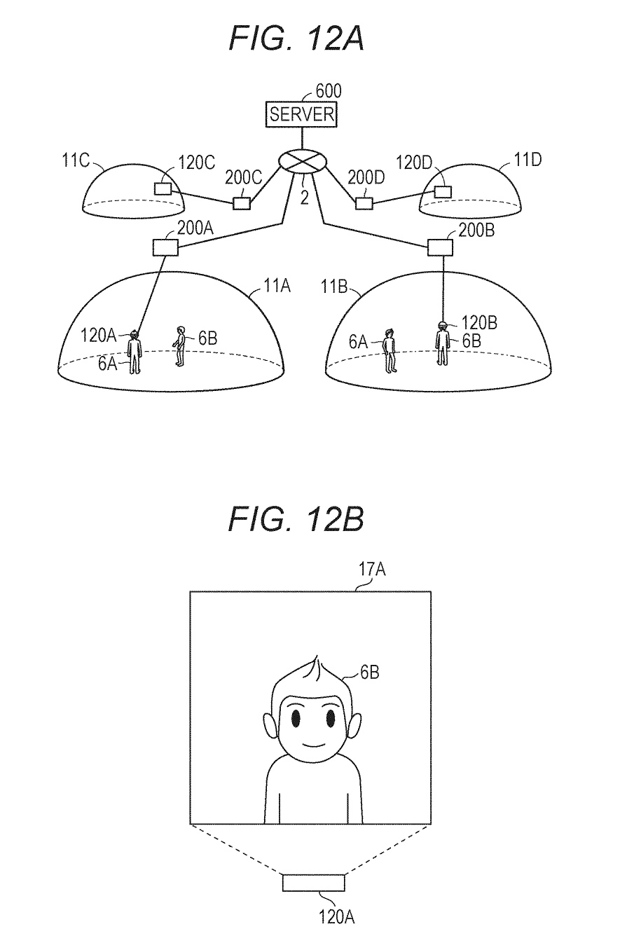

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

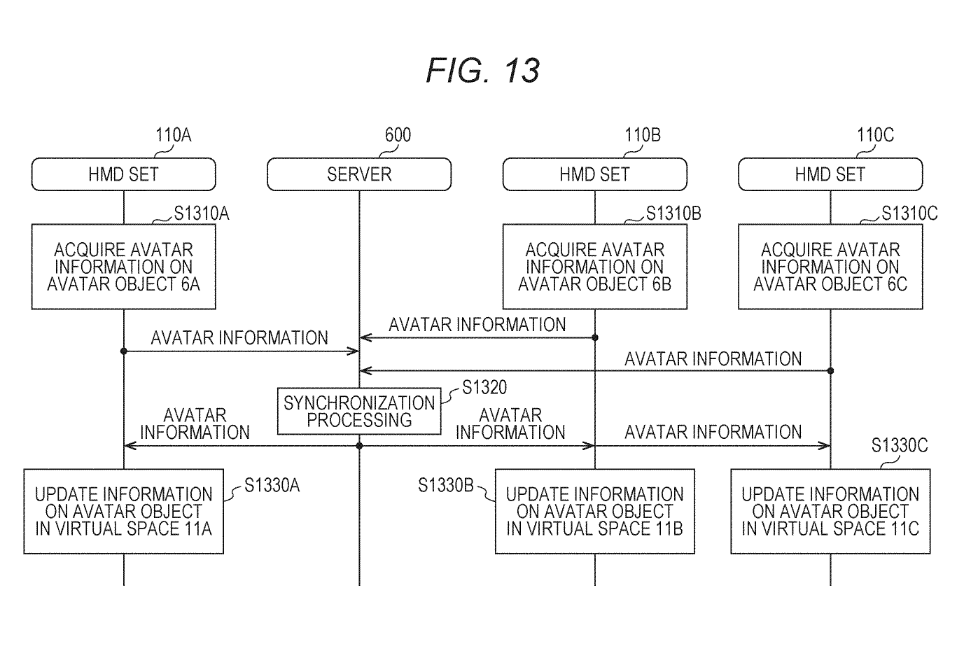

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

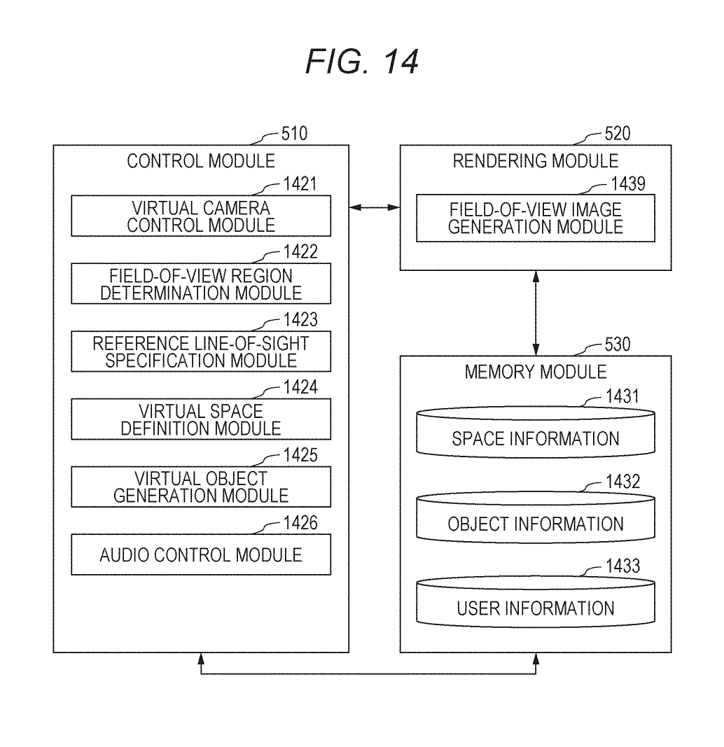

With reference to FIG. 14, a detailed configuration of modules in the computer 200 is described. FIG. 14 is a block diagram of a detailed configuration of modules in the computer 200 according to at least one embodiment of this disclosure.

As in FIG. 14, the control module 510 includes a virtual camera control module 1421, a field-of-view region determination module 1422, a reference line-of-sight specification module 1423, a virtual space definition module 1424, a virtual object generation module 1425, and an audio control module 1426. The rendering module 520 includes a field-of-view image generation module 1439. The memory module 530 stores space information 1431, object information 1432, and user information 1433.

In at least one aspect, the control module 510 controls image display of the HMD 120 on the monitor 130. The virtual camera control module 1421 arranges the virtual camera 14 in the virtual space 11, and controls the behavior and direction of the virtual camera 14, for example. The field-of-view region determination module 1422 defines the field-of-view region 15 in accordance with the direction of the head of the user 5 wearing the HMD 120. The field-of-view image generation module 1439 generates data of a field-of-view image (also referred to as field-of-view image data) to be displayed on the monitor 130 based on the determined field-of-view region 15. The field-of-view image generation module 1439 also generates field-of-view image data based on data received from the control module 510. The field-of-view image data generated by the field-of-view image generation module 1439 is output to the HMD 120 by the communication control module 540. The reference line-of-sight specification module 1423 specifies the line of sight of the user 5 based on the signal from the eye gaze sensor 140.

The control module 510 controls the virtual space 11 provided to the user 5. The virtual space definition module 1424 generates virtual space data representing the virtual space 11, thereby defining the virtual space 11 in the HMD system 100.

The virtual object generation module 1425 generates data of objects arranged in the virtual space 11. Examples of the objects may include virtual panels, virtual letters, and virtual post boxes. The data generated by the virtual object generation module 1425 is output to the field-of-view image generation module 1439.

The audio control module 1426, which has detected an utterance of the user 5 using the microphone 170 from the HMD 120, specifies the computer 200 to which voice data corresponding to the utterance is to be transmitted. The voice data is transmitted to the computer 200 specified by the audio control module 1426. The audio control module 1426, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information 1431, object information 1432, and user information 1433.

The space information 1431 stores one or more templates defined in order to provide the virtual space 11.

The object information 1432 stores content to be played in the virtual space 11 and information for arranging objects used in the content. Examples of the content may include games and content representing landscapes similar to the ones in the real world. Furthermore, the object information 1432 includes data for arranging virtual panels or other objects in the virtual space 11.

The user information 1433 stores programs for causing the computer 200 to function as the control device of the HMD system 100 and application programs using various types of content stored in the object information 1432, for example. The data and programs stored in the memory module 530 are input by the user 5 of the HMD 120. Alternatively, the processor 210 downloads the programs or data from a computer (e.g., the server 600) that is managed by a business operator providing the content, and stores the downloaded programs or data in the memory module 530.

[Mechanism Causing VR Motion Sickness]

The following describes a cause of the user's 5 VR motion sickness. One of the likely causes of VR motion sickness is sensory conflict between virtual experience and the user's perception or expectation. For example, some field-of-view images provided to the user using the HMD may cause the user to develop an illusion that the user is moving in a direction different from the user's perception. This illusion is generally referred to as visually induced illusion of self-motion (vection). The following describes how field-of-view images cause vection and lead to VR motion sickness in detail.

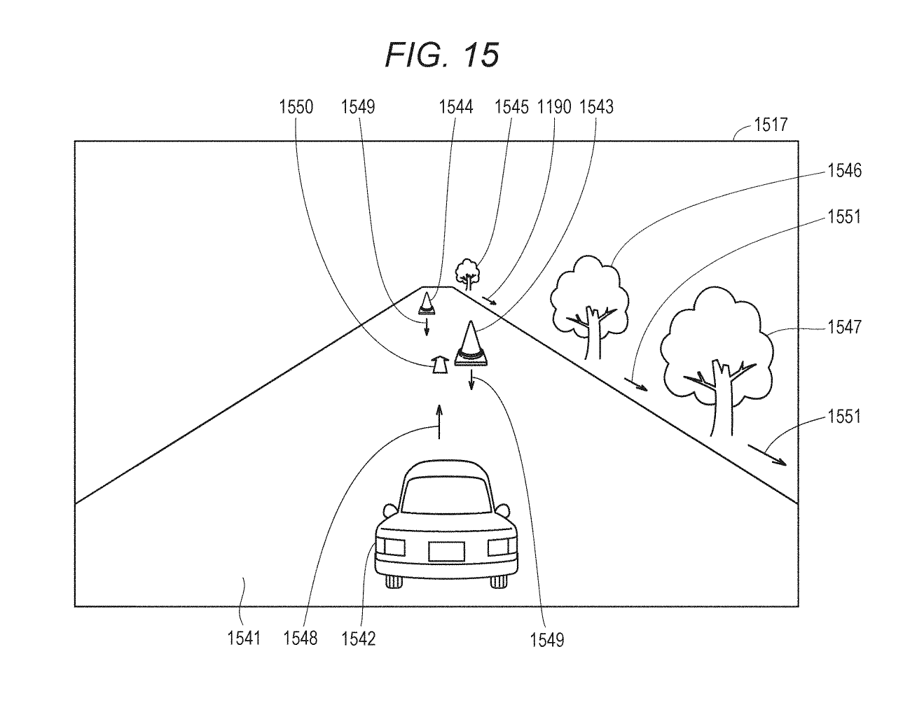

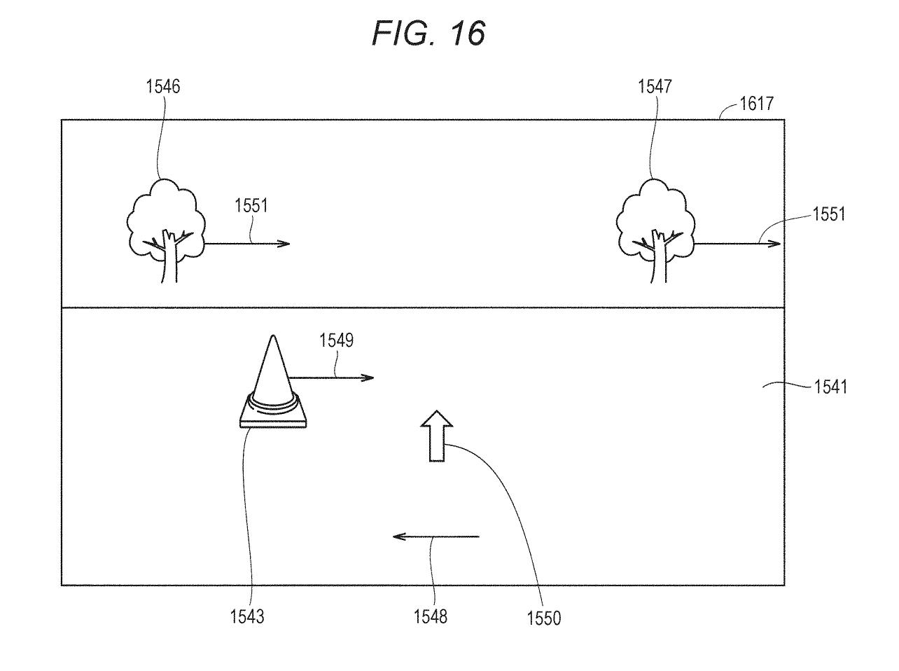

FIG. 15 and FIG. 16 are diagrams illustrating example field-of-view images corresponding to the field of view from the virtual point of view in the virtual space 11. The virtual point of view indicates a position for viewing inside the virtual space 11, that is, a standpoint in the virtual space. Examples of the virtual point of view include the virtual camera 14. A field-of-view range from the virtual point of view is determined in accordance with a line-of-sight direction 1550 from the virtual point of view. The line-of-sight direction 1550 represents the direction in which the virtual camera 14 faces. The line-of-sight direction 1550 is a direction in the virtual space 11 corresponding to the direction in which the head of the user 5 (the HMD 120) faces.

As in FIG. 15 and FIG. 16, a course object 1541, a car object 1542, obstacle objects 1543, 1544, and tree objects 1545, 1546, 1547 are arranged in the virtual space 11. The car object 1542 and the obstacle objects 1543, 1544 are arranged on the course object 1541, whereas the tree objects 1545, 1546, 1547 are arranged out of the course object 1541.

FIG. 15 is a field-of-view image 1517 viewed by the user 5 facing in a front direction. The front direction may be a direction of the HMD 120 when the HMD system 100 starts operating, or may be a direction of the HMD 120 specified by an operation on the controller 300 after the HMD system 100 started operating. In the latter case, the direction of the HMD 120 when the controller 300 is being operated may be referred to as the front direction. In at least one aspect, the line-of-sight direction 1550 on the field-of-view image 1517 of the virtual camera 14 when the user 5 is facing in the front direction matches with a movement direction 1548 of the car object 1542 on the field-of-view image 1517, as in FIG. 15. Specifically, if the XZ plane in the virtual space is assumed to be a horizontal plane, a direction on the horizontal plane of the line-of-sight direction 1550 in the virtual space 11 matches with a direction on the horizontal plane of the movement direction 1548 in the virtual space 11. FIG. 16 is a field-of-view image 1617 viewed by the user 5 facing in a lateral direction (rightward direction).

The field-of-view images 1517, 1617 illustrate scenes in an automatic scrolling game performed in the virtual space 11. The automatic scrolling game is what is called a run game. The run game is, for example, a game in which under the assumption that the car object 1542, which is an operation target of the user 5, automatically moves in the movement direction 1548, the user 5 operates the car object 1542 so as not to collide with the obstacle objects 1543, 1544 or other obstacles to reach a goal.

In the virtual space 11, the virtual camera 14 is arranged such that the virtual camera 14 can monitor the car object 1542 from obliquely above and behind it with respect to the movement direction 1548. The processor 210 moves the car object 1542 in the movement direction 1548 in the virtual space 11. The processor 210 further moves the virtual camera 14 in the movement direction 1548 in association with the movement of the car object 1542 in the movement direction 1548. In at least one aspect, the processor 210 may be configured to arrange the virtual camera 14, not at the position obliquely above and behind the car object 1542, but at a position in the car object 1542 (e.g., driver's seat). This configuration may make the user 5 develop a sense of driving the car object 1542 by him/herself.

As described above, the virtual camera 14 is arranged at the position obliquely above and behind the car object 1542 with respect to the movement direction 1548, and the virtual camera 14 is moved in association with the movement of the car object 1542 in the movement direction 1548. In this case, the position of the car object 1542 on the field-of-view image 1517 is around the center on the lower end of the field-of-view image 1517. The obstacle objects 1543, 1544 move in the movement direction 1549 on the field-of-view image 1517, which means they move from around the center (far side) of the field-of-view image 1517 toward the lower end (near side) of the field-of-view image 1517. In a similar manner, the tree objects 1545, 1546, 1547 move in the movement direction 1551 on the field-of-view image 1517, which means they move from around the center (far side) of the field-of-view image 1517 toward the lower right end (near side) of the field-of-view image 1517. As a result, the user 5 visually recognizes a field-of-view image in which the obstacle objects 1543, 1544 and the tree objects 1545, 1546, 1547 are approaching the car object 1542.

The user 5 moves the car object 1542 in the width direction of the course object 1541 by operating the controller 300, to prevent the car object 1542 from colliding with the obstacle objects 1543, 1135. In at least one aspect, example operations on the controller 300 for moving the car object 1542 in the width direction of the course object 1541 include an input through the posture of the controller 300. For example, the controller 300 may be inclined in a rightward direction in order to move the car object 1542 in the rightward direction, whereas the controller 300 may be inclined in a leftward direction in order to move the car object 1542 in the leftward direction.

The course object 1541 is provided in the virtual space 11 to guide the car object 1542 in the movement direction 1548. In other words, the course object 1541 guides to move the car object 1542 in the movement direction 1548 in the virtual space 11.

In the above-described example, the computer 200 is configured to automatically move the car object 1542 and the virtual camera 14 in the movement direction 1548 in order to implement an automatic scrolling game. In at least one aspect, objects other than the car object 1542 and the virtual camera 14 may be moved in the direction opposite to the movement direction 1548. This is because this configuration also gives the user 5 the sense that the car object 1542 and the virtual camera 14 are moving in the movement direction 1548.

In the field-of-view image 1517, the movement direction 1548 and the line-of-sight direction 1550 face in the same direction. In this state, vection attributed to the field-of-view image 1517 and VR motion sickness are unlikely to occur. This is because if the movement direction 1548 and the line-of-sight direction 1550 face in the same direction, a flow of objects is hard to occur in a wide range on the field-of-view image 1517, and the line of sight of the user 5 does not largely move accordingly.

For example, the obstacle objects 1543, 1544 arranged on the course object 1541 move, as described above, from around the center (far side) of the field-of-view image 1517 toward the lower end (near side) of the field-of-view image 1517. In this case, on the field-of-view image 1517, as the obstacle objects 1543, 1144 move from the far side toward the near side, the obstacle objects 1543, 1544 are displayed gradually larger. For this reason, movement of the positions of the obstacle objects 1543, 1544 (e.g., center position) on the field-of-view image 1517 is limited in a local area, whereby no flow in a wide range occurs in the field-of-view image 1517. For example, the tree objects 1545, 1546, 1547 arranged out of the course object 1541 move, as described above, from around the center (far side) of the field-of-view image 1517 toward the lower right side (near side) of the field-of-view image 1517. In this case, on the field-of-view image 1517, as the tree objects 1545, 1546, 1547 move from the far side toward the near side, the tree objects 1545, 1546, 1547 are displayed gradually larger. For this reason, movement of the positions of the tree objects 1545, 1546, 1547 (e.g., center position) on the field-of-view image 1517 is also limited in a local area.

In this manner, if the movement direction 1548 and the line-of-sight direction 1550 face in the same direction, the movement directions of the obstacle objects 1543, 1544 and the tree objects 1545, 1546, 1547, which move relative to the virtual camera 14 or the car object 1542, are such movement directions that close in the car object 1542 and the virtual camera 14. For this reason, a flow of objects in a wide range is hard to occur on the field-of-view image 1517, and the line of sight of the user 5 is unlikely to be misled by this flow. Therefore, the field-of-view image 1517 is unlikely to cause vection and VR motion sickness.

The following describes the field-of-view image 1617 in FIG. 16. The field-of-view image 1617 is an image displayed on the monitor 130 when the user 5 turns his or her head in a rightward direction from the state of the field-of-view image 1517. Specifically, the field-of-view image 1617 is an image displayed on the monitor 130 when the user 5 turns his or her head 90 degrees clockwise around the y axis from the state facing in the front direction. In the field-of-view image 1617, the line-of-sight direction 1550 is largely inclined with respect to the movement direction 1548. In this state, field-of-view image 1617 is likely to cause vection and VR motion sickness. This is because, if there is a large inclination between the movement direction 1548 and the line-of-sight direction 1550, a flow of objects in a wide range is likely to occur on the field-of-view image 1617, which makes it easy to move the line of sight of the user 5. As a result, the user 5 may get an illusion as if he or she is moving while he or she is actually not.

In the field-of-view image 1617 in FIG. 16, the obstacle object 1543 moves in the movement direction 1549 and the tree objects 1546, 1547 move in the movement direction 1551. Therefore, the obstacle object 1543 and the tree objects 1546, 1547 move from the left end toward the right end of the field-of-view image 1517. As a result, the user 5 visually recognizes a field-of-view image in which the obstacle object 1543 and the tree objects 1546, 1547 are moving from left to right.

In this manner, if the line-of-sight direction 1550 is inclined largely with respect to the movement direction 1548, the movement directions of the obstacle object 1543 and the tree objects 1546, 1547, which move relative to the virtual camera 14 and the car object 1542, are movement directions intersecting with the virtual camera 14. For this reason, movement of the positions of the obstacle object 1543 and the tree objects 1546, 1547 (e.g., center position) on the field-of-view image 1617 extend a wide area, leading to a flow in a wide range on the field-of-view image 1517. As a result, the line of sight of the user 5 is easily misled by this flow, whereby the field-of-view image 1617 is likely to cause vection and VR motion sickness.

[Configuration for Reducing VR Motion Sickness]

As described above, the user 5 is likely to develop VR motion sickness if the angle formed by the movement direction 1548 and the line-of-sight direction 1550 (hereinafter also referred to as “angle difference”) is large. Specifically, the angle difference is the angular difference formed by the movement direction 1548 and the line-of-sight direction 1550 about the Y axis in the virtual space 11. To address this issue, the processor 210 according to at least one embodiment reduces VR motion sickness of the user 5 based on the absolute value of the angle difference. The absolute value of the angle difference represents a degree of inclination of the line-of-sight direction 1550 with respect to the movement direction 1548. Therefore, the angle difference has the same absolute value both when the line-of-sight direction 1550 is inclined 10 degrees clockwise with respect to the movement direction 1548 and when the line-of-sight direction 1550 is inclined 10 degrees counterclockwise with respect to the movement direction 1548.

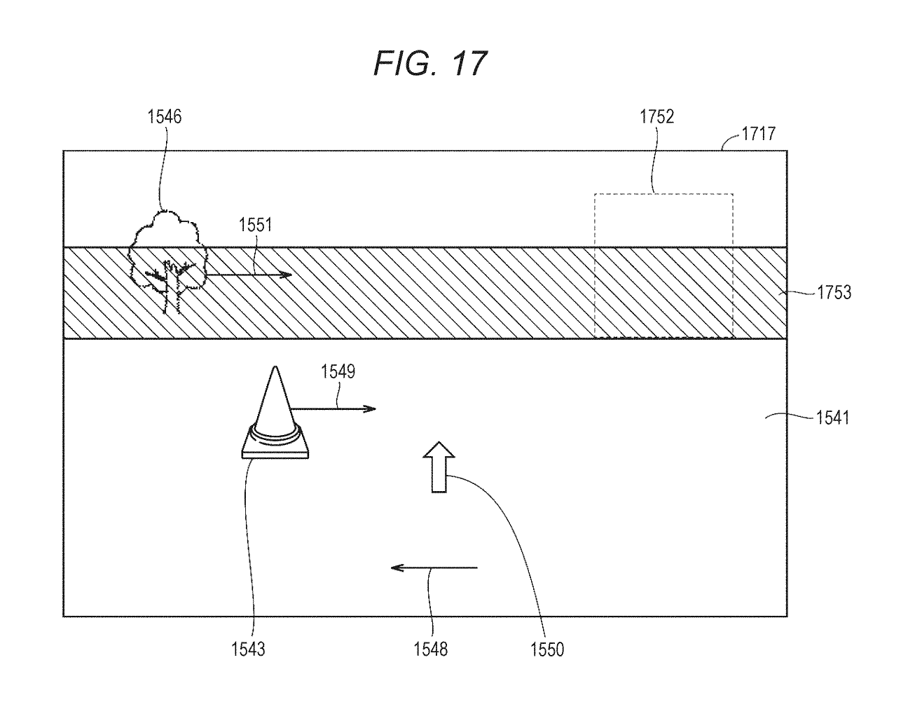

More specifically, if the absolute value of the angle difference is larger than “0”, the processor 210 lowers the visibility of objects included in the field-of-view range (shooting range) of the virtual camera 14 compared with the case in which the absolute value of the angle difference is “0”. The object with lowered visibility is hard to be recognized, and thus the flow of the object in the field-of-view image becomes hard to be recognized. As a result, the line of sight of the user 5 is less likely to be misled by this flow; it is unlikely that vection and VR motion sickness will occur. With this configuration, if the absolute value of the angle difference is larger than “0”, the HMD system 100 can reduce occurrence of VR motion sickness developed by the user 5 gazing an object. The following describes processing of lowering the visibility of an object with reference to FIG. 17. FIG. 17 is a field-of-view image 1717 with lowered visibility of an object in the field-of-view image 1617 in FIG. 16.

(Reducing the Number of Environment Objects)

In at least one embodiment, the processor 210 reduces the total number of environment objects arranged in the virtual space 11 when the absolute value of the angle difference is larger than “0” from the total number of environment objects arranged in the virtual space 11 when the absolute value of the angle difference is “0”. Reduction in the total number of environment objects may be conducted not in the virtual space 11 but on the field-of-view image. Examples of such environment objects mainly include objects moving relative to the car object 1542 and the virtual camera 14, but are not limited to these.

A specific example is illustrated in the field-of-view image 1717 in which the tree object 1547, which actually exists, is not arranged in an area 1752 with the absolute value of the angle difference being “90 degrees”.

With this configuration, the processor 210 lowers the possibility that the user 5 gazes environment objects by reducing the total number of environment objects if the absolute value of the angle difference is larger than “0”. In other words, reducing the total number of environment objects lowers the possibility that the line of sight of the user 5 is misled by the flow of the environment objects. Consequently, occurrence of the user's 5 VR motion sickness can be suppressed.

(Changing Colors of Environment Objects)

In at least one embodiment, if the absolute value of the angle difference is larger than “0”, the processor 210 reduces a difference between the color of an environment object and the color of surroundings of this environment object.

For example, if the tree object 1546 is “red” and the color of surroundings (e.g., the panorama image 13) of the tree object 1546 is “blue”, the processor 210 makes the color of the tree object 1546 similar to blue or converts the color into blue.

This configuration makes it difficult for the user 5 to distinguish an environment object and surroundings of this environment object if the absolute value of the angle difference is larger than “0”. In other words, by harmonizing the colors of environment objects and the colors of surroundings of the environment objects, the flow of the environment objects on the field-of-view image becomes hard to recognize. Consequently, the possibility that the line of sight of the user 5 is misled by the flow of the environment objects is lowered, whereby VR motion sickness becomes unlikely to occur. The colors of the environment objects and the colors of surroundings of the environment objects may be harmonized in the virtual space 11 or on the field-of-view image.

(Other Configurations)

In at least one embodiment, if the absolute value of the angle difference is larger than “0”, the processor 210 lowers the resolution of texture used for the environment objects. In at least one embodiment, if the absolute value of the angle difference is larger than “0”, the processor 210 reduces the number of polygons of the environment objects. In other words, the processor 210 may represent environment objects coarsely if the absolute value of the angle difference is larger than “0”. This configuration lowers the visibility of the environment objects, and thus the possibility that the line of sight of the user 5 is misled by the flow of the environment objects is lowered, whereby VR motion sickness becomes unlikely to occur. The coarseness of the environment objects may be adjusted in the virtual space 11 or on the field-of-view image.

In at least one embodiment, if the absolute value of the angle difference is larger than “0”, the processor 210 lowers the visibility of the field-of-view image by changing set values associated with the virtual camera 14. Examples of the set values include the “depth of field” of the virtual camera 14 and functions of the virtual camera 14 corresponding to the “diaphragm” of an actual camera. The processor 210 changes these set values, thereby outputting a blurred field-of-view image to the monitor 130. This makes it difficult for the user 5 to visually recognize environment objects and thus to recognize the flow of the environment objects on the field-of-view image, whereby VR motion sickness becomes unlikely to occur.

In at least one embodiment, if the absolute value of the angle difference is larger than “0”, the processor 210 may perform processing for lowering the visibility of environment objects on surroundings of the environment objects or an area in front of the virtual camera 14. Specifically, the processing for lowering the visibility of environment objects is performed at least on the space between the environment objects and the virtual camera 14 in the virtual space 11. For example, the processor 210 performs fog effect processing, thereby providing “fog” on environment objects or wholly in the virtual space 11. This configuration also makes it difficult for the user 5 to visually recognize environment objects and thus to recognize the flow of the environment objects on the field-of-view image, whereby VR motion sickness becomes unlikely to occur.

(Lowering Visibility of Objects Arranged Out of Course)

In at least one embodiment, environment objects may be objects that move relative to the car object 1542 and the virtual camera 14 and are arranged out of the course object 1541. The processor 210 according to the present embodiment is configured to lower the visibility of environment objects arranged out of the course object 1541 (hereinafter also referred to as “out-of-course object”), among a plurality of environment objects.

If the absolute value of the angle difference is larger than “0”, regardless of whether they are arranged on the course object 1541, environment objects may move in a direction intersecting with the virtual camera 14. Since environment objects arranged on the course object 1541 are closer to the virtual camera 14 than out-of-course objects are, they intersect with the virtual camera 14 for a shorter period of time than the out-of-course objects do. In other words, the environment objects arranged on the course object 1541 intersect with the virtual camera 14 at a higher speed than the out-of-course objects do. In this context, if the speed at which the environment objects intersect with the virtual camera 14 exceeds a certain speed, the environment objects move so fast that the line of sight of the user 5 will be unlikely to be misled by the flow of the environment objects. For this reason, the visibility of environment objects is not necessarily lowered if the environment objects are arranged on the course object 1541 on which the environment objects intersect with the virtual camera 14 at least at a certain speed without fail, while the visibility of the out-of-course objects is lowered. This may eliminate unnecessary visibility lowering processing, thereby reducing processing load.

(Lowering Visibility of Out-of-Course Objects with Shielding Object)

In at least one embodiment, the processor 210 arranges a shielding object 1753 at a boundary part of the course object 1541 (at both ends in the course width direction in this example). The shielding object 1753 shields at least part of an out-of-course object.

If the absolute value of the angle difference is “0”, the processor 210 sets the transparency of the shielding object 1753 to 100%. This means that the user 5 cannot visually recognize the shielding object 1753 if the absolute value of the angle difference is “0”.

If the absolute value of the angle difference is larger than “0”, the processor 210 reduces the transparency of the shielding object 1753. This enables the user 5 to visually recognize the shielding object 1753. Consequently, the shielding object 1753 masks at least part of the out-of-course object. This makes it difficult for the user 5 to visually recognize the out-of-course object, whereby VR motion sickness becomes unlikely to occur.

The shielding object 1753 may be any object capable of shielding out-of-course objects. For example, the shielding object 1753 be a static object such as a guardrail object or a wall object or may be a dynamic object such as a large-sized vehicle object running side by side with the car object 1542. In order to prevent the shielding object 1753 from causing a conspicuous flow on the field-of-view image 1717, the color of the shielding object 1753 is preferably harmonized with the color of surroundings. In other words, the color of the shielding object 1753 is preferably a single color harmonizing with the color of surroundings.

(Lowering Density of Out-of-Course Objects)

To visually recognize out-of-course objects, the user 5 turns his or her head (in other words, the HMD 120). Consequently, the absolute value of the angle difference increases, whereby the user 5 may develop VR motion sickness.

To address this issue, the processor 210 according to at least one embodiment arranges out-of-course objects such that the density of the out-of-course objects is below a predetermined density. For example, the processor 210 arranges out-of-course objects such that the number of out-of-course objects arranged in a unit length along the course object 1541 is below a predetermined number.

With this configuration, the processor 210 reduces the number of times in which the user 5 visually recognizes out-of-course objects, and thus may reduce occurrence of VR motion sickness of the user 5.

[Control Structure]

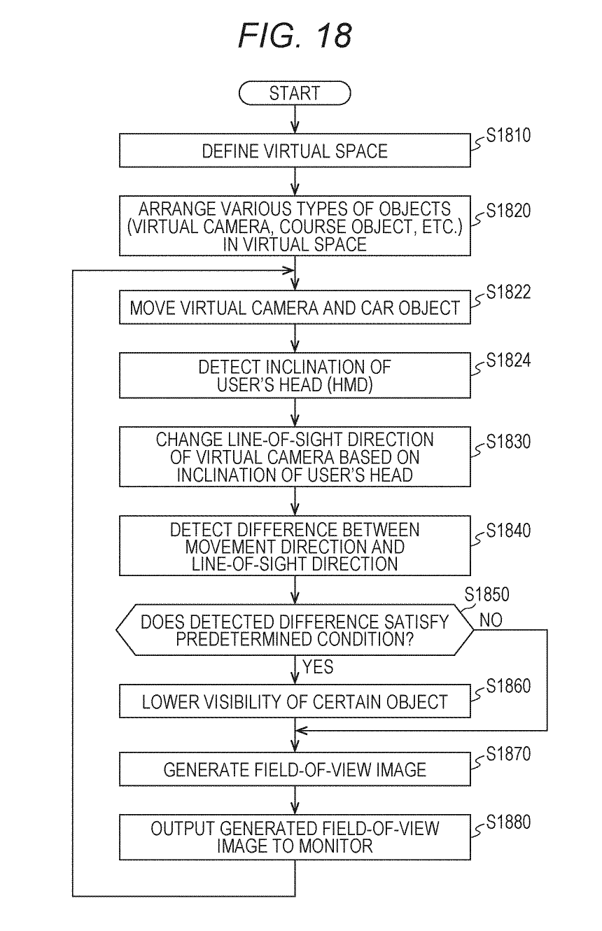

FIG. 18 is a flowchart of a process for lowering visibility of environment objects. The process in FIG. 18 is performed by the processor 210 executing various control programs stored in the memory 220 or the storage 230.

In Step S1810, the processor 210 defines the virtual space 11 in order to provide the user 5 wearing the HMD 120 with virtual experience.

In Step S1820, the processor 210 arranges the virtual camera 14, the car object 1542, the course object 1541, and environment objects in the virtual space 11.

In Step S1822, the processor 210 automatically moves the virtual camera 14 and the car object 1542 along the course object 1541.

In Step S1824, the processor 210 detects a motion (inclination) of the HMD 120. In an example, the processor 210 detects a motion of the head of the user 5 (i.e., motion of the HMD 120) based on an output from the sensor 190 (e.g., gyroscope sensor) provided to the HMD 120.

In Step S1830, the processor 210 changes a direction (line-of-sight direction) in which the virtual camera 14 (virtual point of view) faces, in accordance with the detected motion (inclination) of the head of the user 5.

In Step S1840, the processor 210 detects an angle difference between the movement direction of the virtual camera 14 (virtual point of view) and the line-of-sight direction. In at least one aspect, the processor 210 corrects the direction of the virtual camera 14 such that the movement direction and the front direction of the HMD 120 are in the same direction, before the processing in Step S1822. In an example, the processor 210 prompts the user 5, while facing in the front direction, to push a predetermined button of the controller 300 for a certain period of time (e.g., 3 seconds). The processor 210 matches the line-of-sight direction (the direction in which the virtual camera 14 faces) with the movement direction at the timing of detecting that the button has been pressed for a certain period of time. In this case, the processor 210 detects the yaw angle (θv) of the HMD 120 as the angle difference.

In Step S1850, the processor 210 determines whether the detected angle difference satisfies a predetermined condition. For example, if the absolute value of the angle difference is larger than a first angle (e.g., 30°), the processor 210 determines that the predetermined condition is satisfied.

If the processor 210 determines that the predetermined condition is satisfied (YES in Step S1850), the processor 210 performs processing of lowering the visibility of a certain object (e.g., out-of-course object) included in the field-of-view range of the virtual camera 14 compared with the case in which the absolute value of the angle difference is “0” (in Step S1860). By contrast, if the processor 210 determines that the predetermined condition is not satisfied (NO in Step S1850), the processor 210 performs the processing in Step S18′70.

In the processing in Step S1860, the processor 210 may increase the degree of lowering the visibility of the certain object as the absolute value of the angle difference increases until the absolute value of the angle difference reaches a second angle (for example, 90°). The processor 210 may decrease the degree of lowering the visibility of the certain object as the absolute value of the angle difference decreases until the absolute value of the angle difference reaches a third angle (for example, 1800) from the second angle.

In an example, the processor 210 may perform processing from (1) to (5) below as the absolute value of the angle difference increases until the absolute value of the angle difference reaches the second angle.

(1) Increase the number of certain objects to be deleted.
(2) Increase the degree of making the color of a certain object close to colors around the object.
(3) Increase the degree of lowering the resolution of texture used for a certain object.
(4) Increase the number of polygons constituting a certain object to be deleted.
(5) Increase the degree of lowering the transparency of a shielding object.

In Step S1870, the processor 210 generates a field-of-view image that is an image corresponding to the field-of-view range of the virtual camera 14. In Step S1880, the processor 210 outputs the generated field-of-view image to the monitor 130 of the HMD 120. After that, the processor 210 performs the processing in Step S1822 again.

In the processing described above, if the absolute value of the angle difference exceeds “0”, the processor 210 lowers the visibility of an object compared with the visibility in the case in which the absolute value of the angle difference is “0”. It is difficult for the user 5 to recognize the object with lowered visibility, and thus the flow of the object in the field-of-view image. and thus the flow of the object in the field-of-view image. As a result, the line of sight of the user 5 is less likely to be misled by this flow; it is unlikely that vection and VR motion sickness will occur.

[Case in which Virtual Camera 14 does not Automatically Move]

In the above-described example, the virtual camera 14 (i.e., the virtual point of view in the virtual space 11) is configured to automatically move. In at least one aspect, the virtual camera 14 is configured to move following an input made by the user 5, instead of automatic movement.

In such a case, the processor 210 performs the processing of lowering the visibility of an object based on an angle difference between the movement direction of the virtual camera 14 determined by an input made by the user 5 and the direction (line-of-sight direction) in which the virtual camera 14 faces. In other words, in a case in which the virtual camera 14 does not automatically move, the processor 210 performs the processing of lowering the visibility of an object only while the user 5 is inputting an instruction for moving the virtual camera 14.

[Deletion of Out-of-Course Objects from the Start]

With reference to FIG. 15, a comparison will be made between the movement of the obstacle objects 1543, 1544 and the movement of the tree objects 1545, 1546, 1547 in the field-of-view image 1517. Since the obstacle objects 1543, 1544 are arranged on the course object 1541, the movement of the obstacle objects 1543, 1544 is from around the center of the field-of-view image 1717 to the lower end of the field-of-view image 1717. By contrast, since the tree objects 1545, 1546, 1547 are not arranged on the course object 1541, the movement of the tree objects 1545, 1546, 1547 is from around the center of the field-of-view image 1517 to the lower right of the field-of-view image 1517. As a consequence, although both types of the objects move locally in the field-of-view image 1517, the movement of the tree objects 1545, 1546, 1547 extends in a wider range than the movement of the obstacle objects 1543, 1544 does, and the former is likely to cause the flow of objects. For this reason, out-of-course objects may be deleted from the start, irrespective of the absolute value of the angle difference.

[Configuration of Another HMD]

In the above-described example, the HMD system 100 includes the HMD 120 and the computer 200, and the processor 210 of the computer 200 is configured to execute various types of arithmetic processing. The following describes another configuration example of the HMD system.

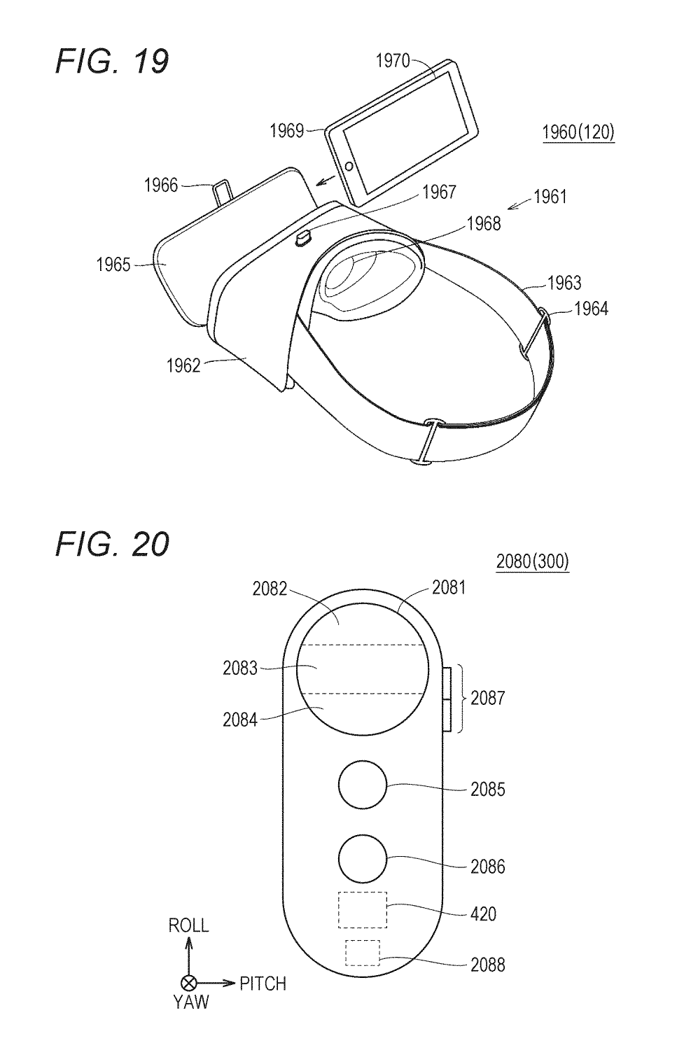

FIG. 19 illustrates the configuration of an HMD system 1960. The HMD system 1960 includes an HMD 1961 and a portable information processor terminal 1969. The HMD 1961 is what is called a mobile HMD including a housing in which a smartphone may be fitted. The HMD 1961 described below includes the above-described sensor 190. The sensor 190 may be used for detecting the direction of the HMD 120.

The HMD 1961 includes a housing 1962, a belt 1963, an adjustment member 1964, a front cover 1965, and a projection 1967. The user 5 fastens the HMD 1961 on his or her head by wearing the belt 1963 around the head and adjusting the length of the belt 1963 with the adjustment member 1964.

The front cover 1965 is provided to a lower front part of the housing 1962 and is pivotable around an attaching part. The front cover 1965 is provided with a hook 1966. The user 5 places the information processor terminal 1969 on the front cover 1965 and then closes the front cover 1965. The user 5 then gets the projection 1967 caught in the hook 1966 with the front cover 1965 closed, thereby securing the information processor terminal 1969 to the HMD 1961.

The housing 1962 also includes lenses 1968. The lenses 1968 include a left-eye lens and a right-eye lens. A part of the housing 1962 on the front side of the lenses 1968 is open. The user 5 wearing the HMD 1961 on his or her head view a monitor 1970 in the information processor terminal 1969 through the lenses 1968. The HMD 1961 may further include an adjustment mechanism for adjusting the positions of the lenses 1968.

The information processor terminal 1969 also includes components (not shown) corresponding to the processor 210, the memory 220, the storage 230, the communication interface 250, the sensor 190, the speaker 180, and the microphone 170 described above. In the HMD system 1960, the above-described various types of processing (e.g., processing for generating the field-of-view image) can be achieved by processors included in the information processor terminal 1969 cooperating with the various types of components.

[Configuration of Another Controller]

FIG. 20 illustrates the configuration of another controller 2080. The user 5 holds and uses the controller 2080 with his or her hands. The user 5 holds the controller 2080 with one hand or both hands.

The controller 2080 includes a touch pad 2081, an application button 2085, a home button 2086, voice volume buttons 2087, motion sensors 420, and a communication interface 2088.

The touch pad 2081 includes a plurality of touch sensors. The touch pad 2081 is configured to determine which area out of areas 2082 to 2084 sectioned in the longitudinal direction of the controller 2080 the user 5 is touching. For example, the user 5 slides a finger from the area 2083 to the area 2082, thereby causing objects arranged in the virtual space 11 to move forward. Alternatively, the touch pad 2081 may include a single touch sensor.

The application button 2085 is a button used in connection with games or other applications. For example, upon detecting that the application button 2085 is pressed, the processor 210 causes the monitor 130 (monitor 1970) to display a menu screen. The home button 2086 is a button for causing the monitor 130 (monitor 1970) to display a predetermined screen (for example, a screen of an application different from the one using the application button 2085). The voice volume buttons 2087 are buttons for adjusting the voice volume of the speaker 180.

The motion sensors 420 in the controller 2080 include a triaxial acceleration sensor and a triaxial angular velocity sensor. As mentioned earlier, the controller 2080 is held in the hand(s) of the user 5. Accordingly, the computer 200 (information processor terminal 1969) is capable of detecting the inclination of the hand(s) of the user 5 based on outputs from the motion sensors 420.

The communication interface 2088 transmits a signal indicating an operation made by the user 5 on the controller 2080 to the computer 200 (information processor terminal 1969). For example, the communication interface 2088 communicates with a counter device in accordance with Bluetooth (registered trademark) or any other near field communication standard.

[Configurations]

The technical features disclosed above may be summarized in the following manner.

(Configuration 1) According to at least one embodiment of this disclosure, there is provided a program executed in a computer for providing virtual experience to a user 5 through an image display apparatus (e.g., the monitor 130, 1970) associated with the head of the user 5. This program causes the computer to execute a step (Step S1810) of defining a virtual space 11 for providing the virtual experience, a step (Step S1822) of moving a virtual point of view (e.g., the virtual camera 14) arranged in the virtual space 11, a step (Step S1830) of controlling a line-of-sight direction of the virtual point of view in accordance with a motion of the head of the user 5, a step (Step S1840) of detecting a difference (angle difference) between a movement direction of the virtual point of view and the line-of-sight direction of the virtual point of view, a step (Step S1860) of, if the absolute value of the difference is larger than 0, lowering visibility of one or more certain objects (for example, out-of-course objects) included in a field-of-view range from the virtual point of view determined in accordance with the line-of-sight direction of the virtual point of view compared with a case in which the absolute value of the difference is 0, a step (Step S1870) of generating a field-of-view image that is an image corresponding to the field-of-view range, and a step (Step S1880) of causing the image display apparatus to output the field-of-view image.

The step of moving the virtual point of view includes absolute movement and relative movement of the virtual point of view in the virtual space 11. The relative movement includes movement of the virtual point of view relative to an object other than the virtual point of view by moving this object. The absolute movement of the virtual point of view includes automatic movement independent from input by the user 5 and movement according to input by the user 5.

The step of controlling the line-of-sight direction of the virtual point of view includes detecting a motion of the head of the user 5 in accordance with a sensor provided to an HMD (or an information processing apparatus mounted on an HMD) the user 5 wears on his or her head.

(Configuration 2) In the program, in the step of lowering, if the absolute value of the difference is larger than a first value that is larger than 0 (YES in Step S1850), visibility of one or more certain objects is lowered compared with a case in which the absolute value of the difference is 0.

(Configuration 3) In the program, in the step of lowering, a degree of lowering visibility of one or more certain objects is increased as the absolute value of the difference increases until the absolute value of the angle difference reaches a second value.

With this configuration, the program lowers the visibility of one or more certain objects even further as the condition that is more likely to cause VR motion sickness. Thus, the flow of the object in the field-of-view image becomes hard to be recognized. As a result, the line of sight of the user 5 is less likely to be misled by this flow; it is unlikely that vection and VR motion sickness will occur.

(Configuration 4) In the program, in the step of lowering, the total number of one or more certain objects is further reduced when the absolute value of the difference is larger than 0 compared with when the absolute value of the difference is 0.

(Configuration 5) In the program, in the step of lowering, a difference between a color of one or more certain objects and a color of surroundings of the one or more certain object is further reduced when the absolute value of the difference is larger than 0 compared with when the absolute value of the difference is 0.

(Configuration 6) The program causes the computer to execute a step (Step S1822) of moving a moving object in a depth direction along a guide object that guides to move the moving object in the depth direction. The virtual point of view is located behind the moving object or above the moving object. In the step of moving the virtual point of view, the virtual point of view is moved in the depth direction in synchronization with movement of the moving object in the depth direction. The one or more certain objects are included in the field-of-view range from the virtual point of view and are arranged out of a range specified by the guide object.

The guide object is not limited to the above-described course object 1541, and includes a signboard object indicating the depth direction, for example. The moving object is not limited to the above-described car object 1542, and includes an object moving in synchronized with the virtual point of view (the virtual camera 14).

(Configuration 7) At a boundary part of the above-described guide object, a shading object 1750 is arranged capable of shading at least part of one or more certain objects from the virtual point of view. In the program, in the step of lowering, transparency of the shading object is further reduced when the absolute value of the difference is larger than 0 compared with when the absolute value of the difference is 0.

(Configuration 8) According to at least one embodiment of this disclosure, there is provided an information processing apparatus including a processor and a memory configured to store a program. By executing the program, this processor defines a virtual space 11 for providing virtual experience, moves a virtual point of view arranged in the virtual space 11, controls a line-of-sight direction of the virtual point of view in accordance with a motion of the head of a user 5, detects a difference between a movement direction of the virtual point of view and the line-of-sight direction of the virtual point of view, if the absolute value of the difference is larger than 0, lowers visibility of one or more certain objects included in a field-of-view range from the virtual point of view determined in accordance with the line-of-sight direction of the virtual point of view compared with a case in which the absolute value of the difference is 0, generates a field-of-view image that is an image corresponding to the field-of-view range, and causes an image display apparatus associated with the head of the user 5 to output the field-of-view image.

(Configuration 9) According to at least one embodiment of this disclosure, there is provided a method executed in a computer for providing virtual experience through an image display apparatus associated with the head of a user 5. This method includes a step of defining a virtual space 11 for providing virtual experience, a step of moving a virtual point of view arranged in the virtual space 11, a step of controlling a line-of-sight direction of the virtual point of view in accordance with a motion of the head of the user 5, a step of detecting a difference between a movement direction of the virtual point of view and the line-of-sight direction of the virtual point of view, a step of, if the absolute value of the difference is larger than 0, lowering visibility of one or more certain objects included in a field-of-view range from the virtual point of view determined in accordance with the line-of-sight direction of the virtual point of view compared with a case in which the absolute value of the difference is 0, a step of generating a field-of-view image that is an image corresponding to the field-of-view range, and a step of causing the image display apparatus to output the field-of-view image.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

It is to be understood that the embodiments disclosed above are merely examples in all aspects and in no way intended to limit this disclosure. The scope of this disclosure is defined by the appended claims and not by the above description, and this disclosure is intended to encompass all modifications made within the scope and spirit equivalent to those of the appended claims.

1. A method comprising:
defining a virtual space, the virtual space including a virtual point of view and a virtual object;
moving the virtual point of view in a first direction;
defining a line-of-sight direction associated with the virtual point of view in accordance with a motion of the head of the user;
defining a field of view in the virtual space based on a position of the virtual point of view and the line-of-sight direction;
detecting an angle between the first direction and the line-of-sight direction;
changing visibility of the virtual object included in the field of view in accordance with the angle;
generating a field-of-view image that is an image corresponding to the field of view; and
causing an image display apparatus to output the field-of-view image.

2. The method according to claim 1, wherein the changing includes
setting the visibility of the virtual object so as to provide a first display mode in accordance with the angle being 0, and
setting the visibility of the virtual object so as to provide a second display mode with lower visibility than in the first display mode in accordance with the angle being larger than 0.

3. The method according to claim 1, wherein the changing further includes
changing the visibility of the virtual object in accordance with the angle being larger than a first value that is larger than 0.

4. The method according to claim 1, wherein the changing includes
setting a degree in change of the visibility of the virtual object in accordance with the angle becoming larger on condition that the angle is smaller than a second value.

5. The method according to claim 1, wherein the changing includes
changing the visibility by changing a total number of virtual objects.

6. The method according to claim 1, wherein the changing includes
changing the visibility by changing a difference between a color of the virtual object and a color of surroundings of the virtual object.

7. The method according to claim 1, wherein
the virtual space further includes a guide object,
the virtual point of view moves along the guide object, and
the virtual object is included in the field-of-view range and arranged outside a range defined by the guide object.

8. The method according to claim 6, wherein
the virtual space further includes a shading object, the shading object being arranged at a boundary part of the guide object and the outside, and
the changing includes changing the visibility by changing a transmittance of the shading object.

9. The method according to claim 6, wherein
the guide object is a road,
a moving object moves on the road, and
the virtual point of view is moved in association of the moving object.

10. The method according to claim 1, wherein
the virtual space further includes a guide object,
the virtual object includes a first virtual object and a second virtual object,
the virtual point of view and the first virtual object are arranged on the guide object or inside the guide object,
the second virtual object is arranged outside the guide object,
the virtual point of view moves along the guide object, and
the changing includes making visibility and the first virtual object and visibility of the second object different.

11. The method according to claim 1, wherein the changing includes making visibility of the second virtual object smaller than visibility of the first virtual object.
